(19) United States
(12) Patent Application Publication
(10) Pub. No.: US 2014/0058876 A1
(43) Pub. Date: Feb. 27, 2014

(54) INTERNET-BASED AUCTION OF TANGIBLE PROPERTY

(71) Applicant: REI TECHNOLOGIES LLC, The Woodlands, TX (US)

(72) Inventor: Michael Jon LEWIS, Houston, TX (US)

(21) Appl. No.: 13/920,973

(22) Filed: Jun. 18, 2013

Related U.S. Application Data
(60) Provisional application No. 61/692,195, filed on Aug. 22, 2012.

(51) Int. Cl. G06Q 30/08; G06Q 50/16

(52) U.S. Cl. CPC G06Q 30/08; G06Q 50/16
USPC 705/26.3

(57) ABSTRACT

A system including a processor configured to communicate over the internet with a plurality of remotely located computer stations and a memory. The memory stores a program that is executable by the processor. The program provides bids for the auction to a plurality of end-users of the plurality of remotely located computer stations, wherein each end-user acquires a bid through a purchase of a product or a service associated with the parcel.

### CROSS-REFERENCE TO RELATED APPLICATIONS

This application claims the benefit of U.S. Provisional Application No. 61/692,195, filed Aug. 22, 2012, the disclosure of which is herein incorporated by reference in its entirety.

### FIELD OF THE INVENTION

The present invention relates to a devices, systems, methods, and computer-readable mediums for providing internet-based auctions, and more particularly, to internet-based auctions of tangible property, such as real estate property.

### BACKGROUND OF THE INVENTION

Traditional auctions award tangible property to the highest bidder. The tangible property is offered at a “starting price,” which progressively increases as bids are received. Typically, bids are free and there is no limit to the size or number of bids. At the conclusion of the auction, the highest bidder purchases the tangible property at the last offered price. In general, the participants (or their representatives) are physically present.

The internet allows for auctions with geographically-remote participants. There are numerous auction sites for tangible property. EBay, for example, provides free and unlimited bids to end-users—an end-user can participate merely by obtaining a user name and a password. There is no limit to the size of a bid. An EBay auction proceeds like a traditional auction—each bid may increase the price by any amount and the auction concludes at a set time or when no additional bids are received.

Traditional auctions and common auction sites like EBay offer little incentive for participation unless an end-user has a need for a particular piece of property. If there are multiple end-users with that need, then competitive bidding is likely to escalate the price and the end-user with the highest bid is thus unlikely to get below market prices. “Penny auctions” try to deliver below market prices to the highest bidder. To participate in the auction, end-users must buy bids. As a bid is used in the auction, the price of a good increases by a set increment, typically a nominal value such as a penny (hence, “penny auction”). When the auction ends, the highest bidder theoretically pays substantially less than the market value because the maximum price of the tangible property is limited (number of bids times the set increment). The auctioneer collects revenue through the purchase of bids for the auction, and this revenue offsets the loss incurred by selling tangible property at below market price. Although such penny auctions incentivize participation by offering below market prices, they may have difficulty selling bids because the end-user perceives no value in purchasing bids.

Additionally, such known penny auction sites are not suitable for high-cost items. To cover the expenditure associated with a high-cost item, a penny auction must generate revenue by either increasing the cost of each bid or increasing the number of bids sold. Both solutions are problematic: increasing the cost of each bid may reduce the number of total bids received and increasing the number of bids sold requires additional end-user participation. For this reason, penny auctions have typically been limited to low-cost items.

### SUMMARY OF THE INVENTION

The presently disclosed embodiments are directed to solving one or more of the problems presented in the prior art, as well as providing additional features that will become readily apparent by reference to the following detailed description when taken in conjunction with the accompanying drawings. In some embodiments, internet auction systems provide end-users with an incentive to purchase bids for participation in an auction.

In some embodiments, an auction system for auctioning tangible property comprises a processor and a memory. The processor is configured to communicate over an internet connection with a plurality of remotely located computer stations. The memory stores a program which is executed by the processor, the program configured to provide bids for an auction to a plurality of end-users of the plurality of remotely located computer stations, wherein each end-user acquires a bid through a purchase of a product or a service associated with the tangible property.

In some embodiments, the tangible property is a parcel of real estate and the product or service is at a property inspection report, a property appraisal report, and a property survey report. In some embodiments, the tangible property is a parcel of real estate and the product or service associated with the parcel is a report specific to that property. In some embodiments, the report specific to the property is at least one selected from a background report, a history report, a condition report, a value report, a comparable property report, a transaction report, a market report, an area report, a termite report, a wood-destroying organism report, and a property disclosure.

In some embodiments, the total number of bids is limited to a pre-determined number.

In some embodiments, a total number of bids for each end-user is limited to a pre-determined number.

In some embodiments, the end-user may acquire an additional bid for the auction by repurchasing the product or service.

In some embodiments, an end-user may acquire additional bids for the auction by purchasing multiple products or services together at a discounted price.

In some embodiments, the program provides bids for the auction to one of the end-users when the end-user donates a prescribed amount to a prescribed charity.

In some embodiments, an auction system for auctioning a parcel of real estate comprises a processor and a memory. The processor is configured to communicate over the internet with a plurality of remotely located computer stations. The memory stores a program executed by the processor, the program configured to auction the tangible property to a plurality of end-users of the plurality of remotely located computer stations, wherein each end-user has acquired a bid for the auction through a purchase of a product or a service associated with the tangible property.

In some embodiments, the program is configured to offer a dynamic snapshot to an end-user who places a bid on the tangible property.

In some embodiments, the snapshot provides at least one piece of information selected from the group consisting of a number of end-users in the auction, a number of bids remaining in the auction, a number of bids remaining for another end-user in the auction, and a prior bidding pattern of another end-user in the auction.

In some embodiments, auctioning the tangible property comprises setting a base-price at the beginning of the auction.

In some embodiments, the base-price is increased by an increment when one of the plurality of end-users places a bid.

In some embodiments, the program resets a timer when one of the plurality of end-users places a bid.

In some embodiments, the program is configured to reset a timer when one of the end-users places a bid.

In some embodiments, the program is configured to reset the timer only if the timer is below a predetermined value when the bid is placed.

In some embodiments, the timer is reset to a value less than the predetermined value.

In some embodiments, the timer is reset to progressively smaller times with each subsequent bid.

In some embodiments, a method of auctioning tangible property comprises communicating with a plurality of remotely located computer stations over an internet connection, providing an auction-interface to a plurality of end-users of the plurality of remotely located computer stations, and receiving bids for the parcel from the end-users, wherein each end-user acquires a bid for the auction through a purchase of a product and a service associated with the parcel.

In some embodiments, the tangible property is a parcel of real estate and the product or service associated with the parcel is at least one selected from the group consisting of a property inspection report, a property appraisal report, and a property survey report.

In some embodiments, the product or service is at least one selected from a background report, a history report, a condition report, a value report, a comparable property report, a transaction report, a market report, an area report, a termite report, a wood-destroying organism report, and a property disclosure.

In some embodiments, an auction system comprises a means for communicating with a plurality of remotely located computer stations over an internet connection and a means for storing a program executed by the program. The program provides bids for an auction to a plurality of end-users of the plurality of remotely located computer stations, wherein each end-user acquires a bid through a purchase of a product or a service associated with the tangible property.

### BRIEF DESCRIPTION OF DRAWINGS

FIG. 1 depicts a method of performing an auction in accordance with some embodiments described herein.

FIG. 2 depicts a method for resetting an auction timer during an internet-based auction in accordance with some embodiments described herein.

FIG. 3 depicts a method of awarding bids to an end-user for an auction of tangible property in accordance with some embodiments described herein.

FIG. 4 depicts schematically the basic components of an exemplary network environment in which new methods for a network-based auction system can be performed.

### DETAILED DESCRIPTION

Disclosed herein are devices, systems, methods, and computer-readable mediums for providing an internet-based auction. The subject of the auction may be tangible property, such as a parcel of land. Participants in the auction acquire bids for the auction by purchasing one or more of products or services associated with the tangible property. In embodiments where the tangible property is real estate, the product or service may be, for example, a property inspection report, a property appraisal report, a property survey report, a copy of the property title, a virtual walkthrough, an actual walkthrough guided by a real estate expert, a RESNET “green” inspection report, and/or a tax certificate. Other embodiments may include other products or services associated with the tangible property. In some embodiments, a plurality of bids are awarded for each purchase, wherein the number of bids awarded may be the same or different for each product or service. In some embodiments, the total number of bids distributed for each auction is limited.

Through the above systems and methods, end-users may, for example, acquire bids through the purchase of a property appraisal report. This bid may then be used for entry in an auction, where the highest bidder may purchase the property at less than market prices. The purchase price may be limited by restricting bids to a small increment. For example, if the bid were one penny and 100,000 participants participated with one bid each, the maximum price the property could reach is $1,000 (100,000 bids×$0.01 increment for each bid). Because both the cost of the products/services and the auction price of the property are less than the market price of the property, the highest bidder may acquire the property for a total expenditure less than the market price of the property.

The systems and methods disclosed herein may be beneficial in the enormous scalability potential of combining the competitive nature of auction sites with the power of crowd sourcing and social networking. The systems and methods described herein could be repeated in viable communities around the world, increasing the size, scope, and number of participants involved.

In some embodiments, a method of an internet-based auction of tangible property includes an end-user registering on a web-site. The end-user purchases a service associated with the tangible property and thereby acquires bids for the auction of tangible property. Multiple end-users participate in the auction. The end-user with the highest bid at the end of the auction has the right and the obligation to purchase the tangible property at the highest bid. In some embodiments, receipt of the title to the property is televised for marketing purposes. In some embodiments, the tangible property is sold “as-is.”

In some embodiments, the auction may begin at a predetermined time. A clock may countdown from, for example, one hour. When the auction begins, the clock starts. The sales price of the home may be offered at a base price (for example, one penny) at the beginning of the auction. End-users can use each of their bids to offer increasingly higher purchase prices. When the clock runs out, the highest bidder has the right and the obligation to purchase the item at the amount of the highest bid.

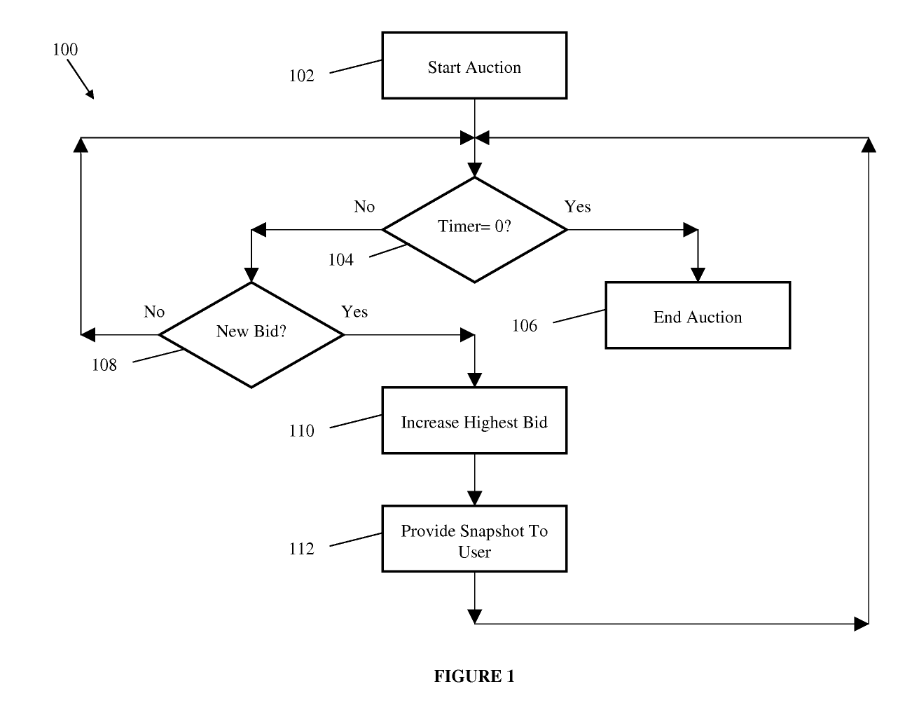

FIG. 1 depicts a method 100 of performing an auction in accordance with some embodiments. Method 100 may be performed by a computer comprising a program configured to execute the steps of method 100. Such a computer may include any processor, control device, software, hardware, logic, etc., capable of executing the steps of the method. A computer may be a personal computing device, workstation, server, handheld computing device, or any other suitable type of microprocessor-based device. The computer in some embodiments may have additional functions not described herein and/or a system may include other computers for additional functions.

The auction is started at step 102. The method first determines at 104 whether the timer has expired. If the timer has expired, the auction ends at 106. If the method determines at step 104 that the timer has not expired, the auction next determines at 108 if a new bid has been placed by an end-user. If no new bid has been placed, the method returns to step 104. If a new bid has been placed, the method increases at 110 the highest bid. As described below, this increase could be a predetermined increment or could be determined by the end-user placing the bid. The method then provides at 112 a snapshot to the end-user who placed the bid. The method then returns to step 104.

Although not depicted in FIG. 1, the method could determine if a new bid has been received in a number of ways. For example, once a new bid is received in the auction system, a flag may be set to “on” in a readable memory. As part of the method 100, the system may access the memory to determine if the flag is set to “on.” If it is, then the system notes that a new bid has been received and sets the flag to “off.” If the flag is not set to “on,” then the system notes that no new bid has been received.

Revenue is generated for the operator of the auction system through end-users' purchase of the products or services and the final sales prices of the tangible property. In some embodiments, the final sales price may be donated to a local charity for marketing purposes.

In some embodiments, the base price may not be one penny. In such embodiments, the base price may be calculated to recoup a percentage of the cost associated with operating the auction system. Such base prices may be characterized as a percentage of an appraised or purchase price of the tangible property and may be, for example, 1%, 2%, 3%, 4%, 5%, 6%, 7%, 8%, 9%, 10%, 15%, or 20% of the appraised or purchase price.

In some embodiments, the base price may be increased by one penny per bid. In other embodiments, the base price may be increased by an increment calculated to recoup a percentage of the cost associated with establishing and running the auction, assuming a minimum number of bids are received. Such increments may be characterized as a percentage of an appraised or purchase price of the tangible property and may be, for example, 0.1%, 0.2%, 0.3%, 0.4%, 0.5%, 0.6%, 0.7%, 0.8%, 0.9%, 1%, 1.5%, or 2% of the appraised or purchase price. In some embodiments, the end-user is permitted to choose the size of the increment when placing a bid.

In some embodiments, the total number of bids in an auction for a specific piece of tangible property is limited. In some embodiments, no products or services related to the property may be purchased within an hour, for example, of the start of the auction. In some embodiments, once the timer reaches a certain point, each bid may reset the clock to a fractionally smaller time. For example, once the timer reaches 5 seconds, the clock will be reset every time someone bids. The clock may be reset to a fractionally smaller time (for example, 5 seconds, 4.99 seconds, 4.98 seconds, etc.) with each subsequent bid. This may beneficially permit the auction to end within a reasonable time frame.

In some embodiments, a product or a service may be purchased during an auction. In some further embodiments, the number of bids for each end-user before the auction is limited, with additional bids purchased during the auction. In some embodiments with in-auction purchasing, a product or a service can be purchased at any time during the auction. In other embodiments with in-auction purchasing, certain products or services are available only at a certain times during the auction, or only after an end-user has placed a certain number of bids.

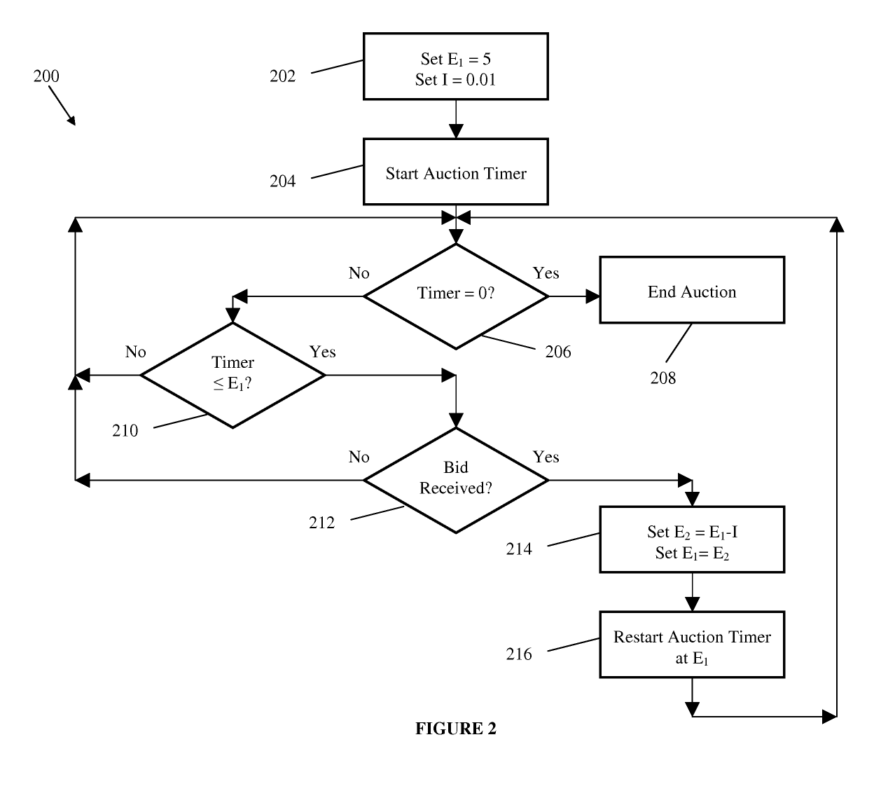

FIG. 2 depicts a method 200 for resetting an auction timer during an internet-based auction in accordance with some embodiments. Method 200 may be performed by a computer configured to execute the steps of method 200. Such a computer may include any processor, control device, software, hardware, logic, etc., capable of executing the steps of the method. A computer may be a personal computing device, workstation, server, handheld computing device, or any other suitable type of microprocessor-based device. The computer in some embodiments may have additional functions not described herein and/or a system may include other computers for additional functions.

In method 200, the timer is set at the beginning of the auction, then reset each time a bid is received within a predetermined ending-period E₁, wherein the timer is progressively reset to a shorter time by an increment I.

Method 200 begins by setting at 202 both value E₁ to a predetermined time and value I to a predetermined increment. The auction timer is then started at 204. In the exemplary method 200, E₁ is set at 5 seconds and I is set at 0.01 seconds. However, method 200 may be used for any ending-period E₁ and increment I without deviating from the scope of this disclosure.

Next, the method determines at 206 if the auction timer has expired. If it has, the auction is ended at 208. If the timer has not expired, the method then determines at 210 if the timer is within the end-period E₁. If the timer is not within the end-period E₁, the method returns to step 206. If the timer is within E₁, then the method determines at 212 if a new bid has been received.

Although not depicted in FIG. 2, the method could determine if a new bid has been received in a number of ways. For example, once a new bid is received in the auction system, a flag may be set to “on” in a readable memory. As part of the method 200, the system may access the memory to determine if the flag is set to “on.” If it is, then the system notes that a new bid has been received and sets the flag to “off.” If the flag is not set to “on,” then the system notes that no new bid has been received.

Returning to FIG. 2, if it is determined that no new bid has been received, the method returns to step 206. If it is determined that a new bid has been received, the method resets at 214 the end-period E₁ to the previous end-period less the increment I. For example, when the initial end-period is 5 and the increment is 0.01, the new end-period is 4.99. In the next cycle of the method 200, if a new bid is received, the new end-period is 4.98.

The method then restarts at 216 the auction timer at the new end-period and returns to step 204.

In some embodiments, a bidding end-user is rewarded with a dynamic “snapshot” of information relevant to the auction. That is, when a user places a bid, that user may be awarded with one or more pieces of information that provide an advantage in the auction. The level of the value of the information may increase with each bid. The information may include: the number of end-users in the auction, the number of bids remaining in the auction, the number of bids remaining for another end-user in the auction, and/or a prior bidding pattern of another end-user in the auction. A prior bidding pattern may describe, based on the other end-user's prior participation in auctions for other tangible properties, one or more of an end-user's predilection to vote at a particular time in an auction, an end-user's users ratio of auction wins to auction participation, an end-user's ratios of auction second-places to auction participation, and the percentage an end-user has not bid in an auction. In some embodiments, the bidding end-user may choose which item of information they wish to receive.

In some embodiments, if a bid is not used in an auction, then that bid cannot be reused in an auction for another tangible property. In some embodiments, the total number of each end-user's bid for an auction is limited. In other embodiments, an end-user may acquire as many bids as they wish by, for example, repeatedly purchasing the services or products offered with the tangible property.

In some embodiments, an end-user may be awarded one or more bids upon registration. In some embodiments, an end-user, once registered, may be awarded a product or service associated with tangible property subject to a future auction. In some embodiments, an end-user who does not end the auction with the highest bid may retain some or all of his or her bids for future auctions. In some embodiments, an end-user with the highest bid may trade remaining bids for a lower purchase price of the tangible property.

In some embodiments, a first end-user may acquire one or more bids by referring a second end-user to a web-site providing the internet-based auctions described herein. In further embodiments, one or more bids are awarded to the first end-user when the second end-user completes registration on the web-site. In some embodiments, one or more bids are awarded to the first end-user when the second end-user purchases one or more of a product or service associated with a tangible property. In some further embodiments, the one or more bids may be awarded to the first end-user for the second-end user's first purchase only, but in other embodiments, the first end-user may be awarded one or more bids for every purchase by the second end-user, or a subset of those purchases. In some further embodiments, the one or more bids awarded to the first end-user may be associated with a tangible property for which the second end-user purchased a product or service. In other embodiments, the one or more bids awarded to the first end-user may be associated with any tangible property, not just the tangible property for which the second end-user purchased a product or service

In some embodiments, the products and services purchased comprise one or more of a property inspection report, a property appraisal report, and a property survey report. In some embodiments, the property report comprises one or more details of the physical condition of a parcel of real estate, such as the dimensions of each room in a structure, the condition of the roof, condition of the exterior of the structure, condition of the plumbing system, condition of the electrical system, condition of the heating system, condition of the air conditioning system, condition of the interiors, condition of the insulation and ventilation systems, condition of appliances, and any suggested or required repairs. In some embodiments, the property appraisal report comprises one or more of the current market value of the home, recent sales prices of homes comparable to the property, property tax information, the square footage of livable and garage areas, and exterior and interior photos of comparable sales. In some embodiments, the property survey report comprises one or more of a detailed map of a parcel of real estate, the legal description of the property, dimensions and boundaries for the property, physical drawings of the property in relation to surrounding properties and buildings, the name of the surveyor who prepared the survey, and a Surveyor's Certificate indicating that the information represented on the plan is from field measurement and title research conducted by the surveyor or staff under his or her direct supervision.

In some embodiments, the product or service is one or more of a background report, a history report, a condition report, a value report, a comparable property report, a transaction report, a market report, an area report, a termite report, a wood-destroying organism report, and a property disclosure. In some embodiments, the reports are digital and provided electronically. In some embodiments, the product or service is one or more of a copy of the property title, a virtual walkthrough, an actual walkthrough guided by a real estate expert, a RESNET “green” inspection report, and a tax certificate.

In some embodiments, a group of products or services can be purchased at a reduced rate. In some embodiments, bids can be acquired by donating to a prescribed charity or charities (either at a discounted rate or awarded free of charge). In some further embodiments, the number of bids acquired may be proportional to a certain value. For example, a $10 donation may provide 1 bid, a $20 donation may provide 2 bids, a $30 donation may provide 3 bids, etc. In some embodiments, the relationship between donations and bids may be directly proportional, but the relationship may also be disproportional or non-linear.

In some embodiments, bids are awarded when an end-user participates in an on-line activity. This may include completing a test, a game, a questionnaire, or a marketing survey, for example. In some embodiments, bids may be awarded through the purchase of other tangible goods, such as stickers, t-shirts, or hats, for example. These goods may be branded to advertise one or more auctions. In some further embodiments, the merchandise may be distributed free of charge. In some embodiments, the award of the bid may come with a condition of wearing or otherwise using the merchandise, with the bid actually given to the end-user with proof of wearing/using the merchandise.

In some embodiments, an end-user may acquire bids through a loyalty program. The loyalty program may award bids when an end-user has participated in a predetermined number of auctions. In some further embodiments, the loyalty program may be associated with a third party, such as a credit card, where the end-user can redeem points (or other metric of participation in the loyalty program) by receiving bids for an auction.

As will be clear to those of ordinary skill in the art, an end-user will perceive a value in purchasing a product or service associated with an auction of a tangible property. The product or service may provide end-users with information such as the desirability of owning the tangible property or the amount that he or she is willing to bid for that property, for example. In addition, the end-user is encouraged to purchase the products or services not only by the information provided, but also by the award of bids. This is especially true where bids cannot be purchased directly.

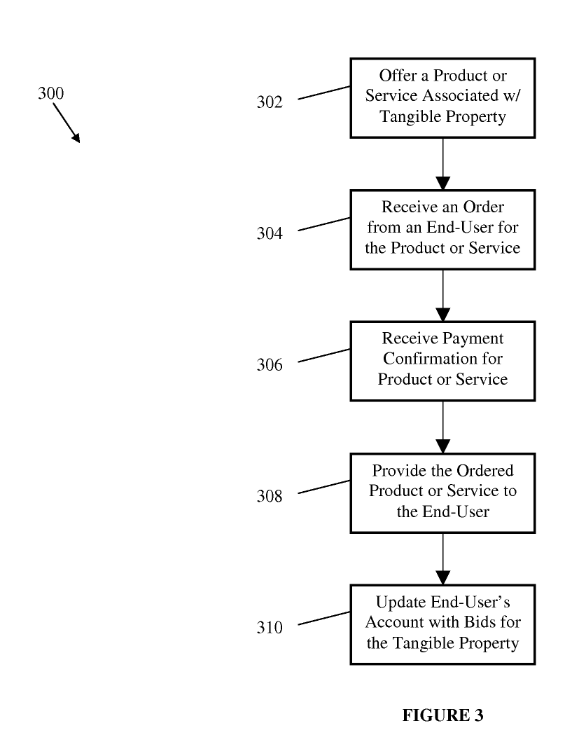

FIG. 3 depicts a method 300 of awarding bids to an end-user for an auction of tangible property in accordance with some embodiments. Method 300 may be performed by a computer configured to execute the steps of method 300. Such a computer may include any processor, control device, software, hardware, logic, etc., capable of executing the steps of the method. A computer may be a personal computing device, workstation, server, handheld computing device, or any other suitable type of microprocessor-based device. The computer in some embodiments may have additional functions not described herein and/or a system may include other computers for additional functions.

Method 300 begins by offering at 302 a product or service associated with tangible property to one or more end-users, wherein the tangible property is the subject of a future auction. The system executing method 300 then receives at 304 an order from an end-user to purchase the product or service and receives payment at 306 from the end-user. Method 300 then provides at 308 the ordered product or service to the end-user and updates 310 the end-user's account with one or more bids for the auction of the tangible property.

Although the embodiments described above have been discussed primarily in terms of a real estate, other tangible property is envisioned. Other tangible property may include, but is not limited to, automobiles, timeshares, retails goods, for example. For different tangible properties, correspondingly different products or services may be offered. For example, if the tangible different property is an automobile, the product or service may include an ownership history, an accident history, an aesthetic condition, a mileage, a maintenance report, warranty report, an inspection history, a test-drive, or a list of comparable vehicles for sale in a geographic region, for example. If the tangible property is a timeshare, the product or service may include property management identification, annual maintenance fees, allocation of maintenance fees, predicted maintenance fee inflation, comparable property value estimates, other timeshare locations within the property ownership's portfolio, how points are accumulated, where in the property ownership's portfolio points can be used for a vacation, or how ownership in the timeshare will be vested (biennial ownership, fixed time ownership, floating time ownership, etc.). If the tangible property is a retail good, the product or service may include product review(s), product manual(s), or other product information, for example.

Non-tangible property is also envisioned. For example, auctions for business services, personal services, or event tickets may employ any of the bid-award systems described herein. If the auction is for a business service or a personal service, bids may be awarded when an end-user purchase a review of the service, for example. If the auction is for an event ticket, bids may be awarded when an end-user purchases a review of a prior occurrence(s) of the event, pictures of a prior occurrence(s) of the event, or a review/pictures of the event location, for example.

In some embodiments the bids are sold as “auction seats.” An end-user may acquire one or more seats through the purchase of a product or service associated with the tangible property in the auction. In some embodiments, the auction may be a “penny auction,” a “dollar auction,” a “pay-per-bid” auction,” or “a bidding fee auction.”

In some auctions there may be a highest bidder cash buy back option for a percentage of the appraised value. In some embodiments, if the highest bidder fails to meet the terms of the purchase, the purchase option will go to the next highest bidder.

The embodiments described above may operate on one or more server computers that allow interconnected computer network users to participate in a network-based auction system. This can be accomplished, for example, by program participants accessing non-transitory computer readable media on a server computer via the internet. This readable media contains the program instructions for accomplishing various steps described above. In the context of this document, a computer-readable storage medium can be any medium that can contain or store programming for use by or in connection with an instruction execution system, apparatus, or device. Such computer readable media may be stored on a memory, where a memory is any device capable of storing a computer readable medium and capable of being accessed by a computer. A memory may include additional features. A computer may include a processor. A processor can be any device suitable to access a memory and execute a program stored thereon.

In some embodiments, an end-user may participate in an auction or purchase reports and/or services for an auction via a mobile consumer product, such as a phone or a tablet.

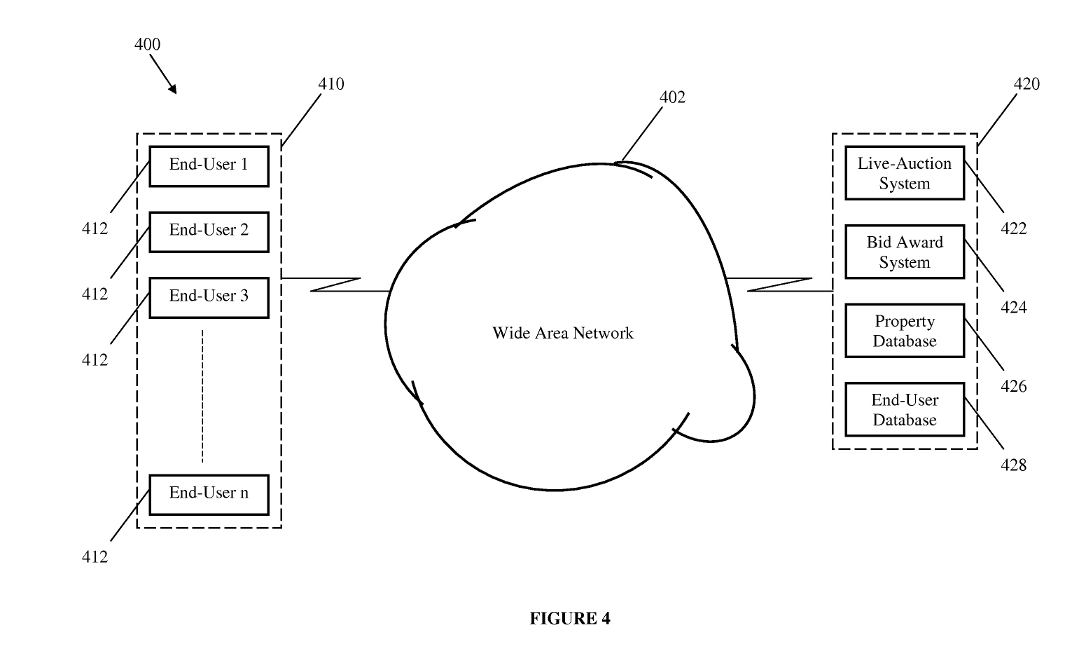

Turning now to FIG. 4, a schematic diagram depicts the basic components of an exemplary network environment in which new methods for a network-based auction system can be performed. A set 410 of end-users 412 access auction systems 420 via a wide area network 402 (e.g., the Internet, direct dial-up, etc.). Typically there are hundreds or even thousands of end-users 412 located at geographically remote locations for each auction. In the case where the wide area network 402 is the Internet, the end-users 412 typically access the auction systems 420 through browsers running on computers stations having Internet access capabilities. The browser may provide an auction interface for the end-users to access the auction.

The end-users 410 may access the auction systems 420 to participate in a live-auction, to purchase services or products related to a tangible property, to access the end-user's account information, or to find lists of tangible property that are being auctioned. The auction system 420 contains a live-auction system 422 for executing a network-based auction, a bid award system 424 for awarding bids for a network-based auction, a property database 426 for storing information related to tangible property that was, is, or will be the subject of a network-based auction, and an end-user database 428 for storing end-user related information, such as past auction performances, the number of bids available to that end-user for an auction of a particular piece of tangible property, etc.

Only authorized end-users 412 of the set of end-users 410 are provided access to an auction to submit bids for a particular tangible property. The authorized participants are those that have previously been awarded a bid for the auction of the particular tangible property, and selective access is enforced by security mechanisms (e.g., passwords) provided by the live auction system 420.

Although not depicted in FIG. 4, a network router may provide a hardware interface to the wide area network 402. The network router may be a Cisco 2524 router, for example. The Cisco 2524 is capable of providing both LAN and WAN access to the auction system 420. The network router may transmit and receive messages to/from a set of local network components via a switch (not shown). The local network components may include local area network links and end nodes (e.g., Web and database servers). The switch and local network components communicate messages via links. An example of a switch is the 3Com SuperStack II 3000. The communication protocol for communications between the network router and the connected local network components may be TCP/IP. The foregoing routers, switches, network components, and communication protocols are offered for exemplary purposes and others may be used in without deviating from the scope of this disclosure.

Although the present invention has been fully described in connection with embodiments thereof with reference to the accompanying drawings, it is to be noted that various changes and modifications will become apparent to those skilled in the art. Such changes and modifications are to be understood as being included within the scope of the present invention. The various embodiments of the invention should be understood that they have been presented by way of example only, and not by way of limitation. Although the invention is described above in terms of various exemplary embodiments and implementations, it should be understood that the various features and functionality described in one or more of the individual embodiments are not limited in their applicability to the particular embodiment with which they are described. They instead can, be applied, alone or in some combination, to one or more of the other embodiments of the invention, whether or not such embodiments are described, and whether or not such features are presented as being a part of a described embodiment. Thus the breadth and scope of the invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known,” and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated. For example, “at least one” may refer to a single or plural and is not limited to either. The presence of broadening words and phrases such as “one or more,” “at least,” “but not limited to,” or other like phrases in some instances shall not be read to mean that the narrower case is intended or required in instances where such broadening phrases may be absent. The word “exemplary” is used herein to mean “serving as an example or illustration.” Any aspect or design described herein as “exemplary” is not necessarily to be construed as preferred or advantageous over other aspects or designs.

It will be appreciated that, for clarity purposes, the above description has described embodiments of the invention with reference to different functional units and processors. However, it will be apparent that any suitable distribution of functionality between different functional units, processing logic elements or domains may be used without detracting from the invention. For example, functionality illustrated to be performed by separate processing logic elements, or controllers, may be performed by the same processing logic element, or controller. Hence, references to specific functional units are only to be seen as references to suitable means for providing the described functionality, rather than indicative of a strict logical or physical structure or organization.

In the foregoing description of exemplary embodiments, reference is made to the accompanying drawings which form a part hereof, and in which it is shown by way of illustration specific embodiments in which the invention may be practiced. It is to be understood that other embodiments may be utilized and structural changes may be made without departing from the scope of the present disclosure.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure.

1. An auction system for auctioning a parcel of real-estate, the system comprising:
a processor configured to communicate over an internet connection with a plurality of remotely located computer stations; and
a memory storing a program to be executed by the processor, the program configured to provide bids for an auction to a plurality of end-users of the plurality of remotely located computer stations, wherein each end-user acquires a bid through a purchase of a product or a service associated with the parcel.

2. The auction system of claim 1, wherein the product or service associated with the parcel is a property inspection report, a property appraisal report, or a property survey report.

3. The auction system of claim 1, wherein the product or service associated with the parcel is a background report, a history report, a condition report, a value report, a comparable property report, a transaction report, a market report, or an area report.

4. The auction system claim 1, wherein a total number of bids for the auction is limited to a pre-determined number.

5. The auction system of claim 1, wherein a total number of bids for each end-user is limited to a pre-determined number.

6. The auction system of claim 1, wherein each end-user may acquire an additional bid for the auction by repurchasing the product or service.

7. The auction system of claim 1, wherein each end-user may acquire additional bids for the auction by purchasing multiple products or services together at a discounted price.

8. The auction system of claim 1, wherein the program provides bids for the auction to one of the end-users when the end-user donates a prescribed amount to a prescribed charity.

9. An auction system for auctioning a parcel of real-estate, the system comprising:
a processor configured to communicate with a plurality of remotely located computer stations over an internet connection; and
a memory storing a program to be executed by the processor, the program configured to auction the parcel of real estate to a plurality of end-users of the plurality of remotely located computer stations, wherein each end-user has acquired a bid for the auction through a purchase of a product and a service associated with the parcel.

10. The auction system of claim 9, wherein the program is further configured to offer a dynamic snapshot to an end-user who places a bid on the parcel of real estate.

11. The auction system of claim 10, wherein the snapshot provides a number of end-users in the auction, a number of bids remaining in the auction, a number of bids remaining for another end-user in the auction, or a prior bidding pattern of another end-user in the auction.

12. The auction system of claim 9, wherein auctioning the parcel of real estate comprises setting a base-price at the beginning of the auction.

13. The auction system of claim 12, wherein the base-price is increased by an increment when one of the end-users places a bid.

14. The auction system of claim 9, wherein the program is configured to reset a timer when one of the end-users places a bid.

15. The auction system of claim 14, wherein the program is configured to reset the timer only if the timer is below a predetermined value when the bid is placed.

16. The auction system of claim 15, wherein the timer is reset to a value less than the predetermined value.

17. The auction system of claim 16, wherein the timer is reset to progressively smaller times with each subsequent bid.

18. A method of auctioning a parcel of real estate comprising:
communicating with a plurality of remotely located computer stations over an internet connection;
providing an auction-interface to a plurality of end-users of the plurality of remotely located computer stations; and
receiving bids for the parcel from the end-users, wherein each end-user acquires a bid for the auction through a purchase of a product and a service associated with the parcel.

19. The method of claim 18, wherein the product or service associated with the parcel is a property inspection report, a property appraisal report, or a property survey report.

20. The method of claim 18, wherein the product or service associated with the parcel is a background report, a history report, a condition report, a value report, a comparable property report, a transaction report, a market report, or an area report.
